(19) United States
(12) Patent Application Publication
(10) Pub. No.: US 2011/0191151 A1
(43) Pub. Date: Aug. 4, 2011

(54) SYSTEM FOR SERVING ADVERTISEMENTS THAT ALLOWS COMPENSATION FOR USER VIEWING

(76) Inventor: Rodney Boyd Rosa, Santa Monica, CA (US)

(21) Appl. No.: 13/018,105

(22) Filed: Jan. 31, 2011

Related U.S. Application Data
(60) Provisional application No. 61/300,209, filed on Feb. 1, 2010.

(51) Int. Cl. G06Q 30/00

(52) U.S. Cl. 705/14.1; 705/14.69

(57) ABSTRACT

A system is provided to serve advertisements to a website in a unique way that can reward all of: the user of the site, the advertiser, and the performer on the website. The system works by allowing the user to elect to view advertisements while watching other content on a website. The user is awarded points or credits based on viewing the advertisements. The points or credits can be later exchanged for goods or merchandise at a store provided on a separate website at a later time.

### CLAIM OF PRIORITY

This application claims priority to U.S. Provisional Application Serial No. 61/300,209, entitled “System For Serving Advertisements That Allows Compensation For User Viewing,” filed Feb. 1, 2010, which is incorporated by reference herein in its entirety.

### BACKGROUND

1. Technical Field

The present invention relates to a system for serving advertisements and providing compensation to the user and other parties for the advertisements served.

2. Related Art

Previous methods of serving advertisements to websites include monitoring the content that users view and serving the advertisements based on the content viewed. Additional user information could be collected to determine the user's interests and advertisement content could be served based on the user interest. In other systems, the advertisements could be directed to the type of website being viewed. For instance, if the website viewed showed cars, the advertisements served could be from automobile sales companies or for auto parts.

A user-directed system provides an advancement over serving advertisements arbitrarily. The arbitrary ad serving nature is akin to advertisements provided in newspapers. The advertisements in newspapers, such as coupons that can be redeemed at grocery stores, provide a separate motivation to encourage shoppers to read the advertisements as well as to shop at a particular store. Other methods of encouraging shoppers to frequent a particular store include the use of trading stamps for groceries. With trading stamps, when a customer shops at a participating grocery store, the customer is rewarded with trading stamps based on the amount of groceries purchased. The trading stamps can then be redeemed for goods or merchandise at a store that accepts the trading stamps. The trading stamps encourage the customer to shop at participating grocery stores rather than at a competing store that does not offer the trading stamps.

It is desirable to provide further methods to serve advertisements to websites that will be more beneficial to advertisers as well as others who are associated with a web page.

### SUMMARY

Embodiments of the present invention serve advertisements to a website in a unique way that can reward all of: the user of the site, the advertiser, and the performer on the website. The system works by allowing the user to elect to view advertisements while watching other content on a website. The user is awarded points or credits based on viewing the advertisements. The points or credits can be later exchanged for goods or merchandise at a store provided on a separate website at a later time. The performer on the website, the advertisement company providing the ads, and others can also receive a portion of the advertisement money along with the user.

In a first embodiment, a user activates the Income Accelerator program. Advertisements are then displayed for a period of time. The user earns credits after the period of viewing time has expired. The user can then exchange the earned credits for merchandise. To prevent abuse by computer-automated viewing, a limited number of viewings can be allowed per hour, and other user identification systems can be used as well. The system program can be downloaded and enabled for use with select programs, or all programs distributed with a system such as Web-TV.

In a second embodiment, a user earns credits based on a multi-click selection system. A first number of earned credits are provided to the user when the user selects or first clicks on one of multiple advertisements displayed along with viewable video content. The first click will bring the user to the store of the advertiser selected. A second number of earned credits are provided to the user when the user selects or clicks on an item in the advertiser's store. The second click will put the advertiser's item into the wish list or shopping basket for the user. A third number of earned credits are provided to the user when the user purchases an item from the user's wish list.

In a third embodiment, the advertiser is provided metrics as a reward when a user clicks to select their advertisement. The advertiser reward system can be provided alone or in combination with the user reward system of the first and second embodiments. The metrics can be provided in the form of information about the individual user clicking the advertisement, or a “dash board” of information about multiple users who watch video content where advertisements are displayed throughout the entire system, effectively providing a real-time Nielsen TV type rating. Data metrics from user selections can be utilized by the advertiser like survey data to determine customers' interest in the product, as well as their response to particular advertisements. The advertiser can interactively make changes to determine user response. For example, an advertiser can reduce the price of its product, offer discounts, or simply change their advertisement content and see if more users will purchase their product based on the change.

In a fourth embodiment, revenue can be obtained by selling metrics data and auctioning limited advertisement space. First, metrics data can be sold that is also provided for free to an advertiser when a user selects its ad. The metrics data can enable other advertisers to tailor their own advertisements and products to best fit viewer content. Further, with limited advertisements displayed to users, providing real-time metrics data enabling advertisers to value ad space can benefit both the advertisers and content providers. Advertisers can bid to get advertisements posted that might not otherwise get displayed using a first-come-first-served sale basis for limited space, and the content provider can benefit from greater advertisement revenue.

The video or Web content provided along with the advertisements can include both a primary video view along with smaller secondary views containing content related to the primary view. A user can select one of the smaller secondary views to replace the primary view. For example, during an automobile race, the overview of the race can be displayed in the primary view, while the in-car-camera view for different drivers can be displayed as smaller secondary views. In another example, during a rock concert the primary view can be the concert stage, while the secondary view can be of the audience or backstage views.

### BRIEF DESCRIPTION OF THE FIGURES

Further details of the present invention are explained with the help of the attached drawings in which:

FIG. 1 shows a video screen shot illustrating the Income Accelerator in combination with a video player and selectable camera angles for embodiments of the present invention;

FIG. 2 is a block diagram illustrating the Income Accelerator system;

FIG. 3 shows a video screen shot illustrating a first embodiment of the Income Accelerator of the present invention where the user is rewarded for viewing time showing user selection of viewing time;

FIG. 4 shows a video screen shot illustrating the first embodiment during a timed viewing of advertisements;

FIG. 5 shows a video screen shot illustrating the first embodiment showing a reward provided to the user after a timed viewing of advertisements;

FIG. 6 is a flowchart showing an example of operation under the first embodiment;

FIG. 7 illustrates a display of advertisements in a second embodiment of the Income Accelerator of the present invention;

FIG. 8 shows a video screen shot illustrating the second embodiment during the viewing of an advertiser's store;

FIG. 9 shows a video screen shot illustrating the second embodiment during the viewing of the user's shopping cart or wish list;

FIG. 10 is a flowchart showing an example of operation under the second embodiment; and

FIG. 11 shows an exemplary “dash board” display containing metrics data.

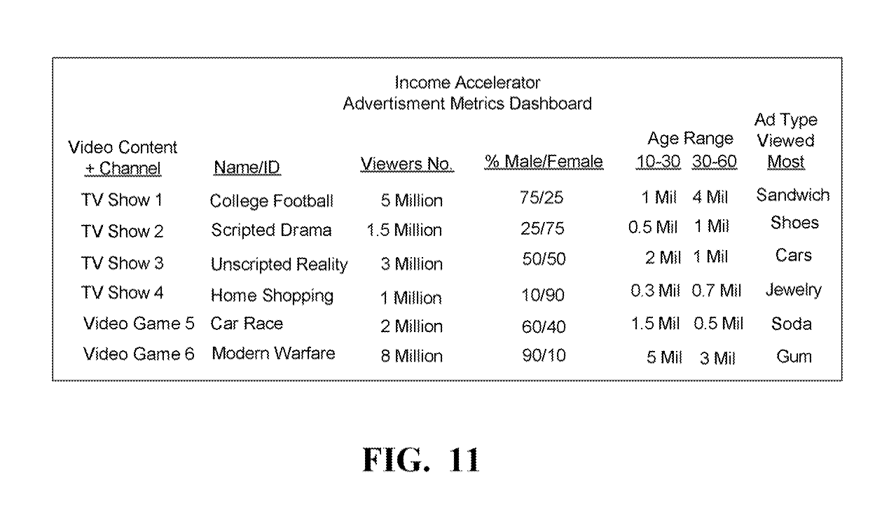

### DETAILED DESCRIPTION

### I. System Overview

A. Income Accelerator Overview

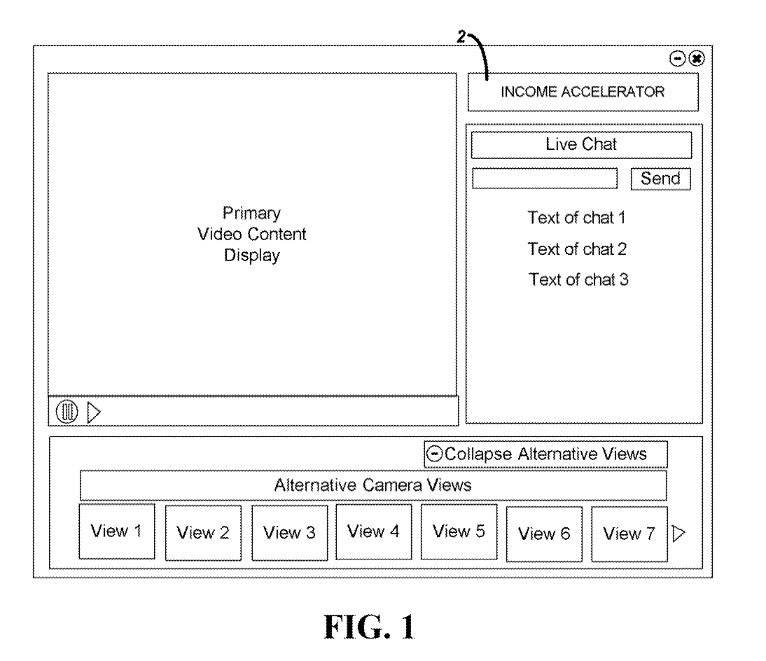

A system according to embodiments of the present invention rewards users for viewing ads and is termed herein as the “Income Accelerator.” The Income Accelerator is provided by a button or cookie 2 illustrated in the upper right hand corner of the web page of FIG. 1 that can be selected. In an alternative embodiment, the Income Accelerator program can be started automatically when the user accesses the video player.

The Income Accelerator is a service that rewards users for viewing and interacting with opt-in advertisements seamless within a video employing rich media applications. The Income Accelerator allows for the display of multiple forms of advertisements to users who elect to view such advertisements with other media content. Users are encouraged to interact with the advertisements that interest them, providing advertisers with a more engaged and active audience to market to. These opt-in advertisements have the potential to generate a higher level of user interest.

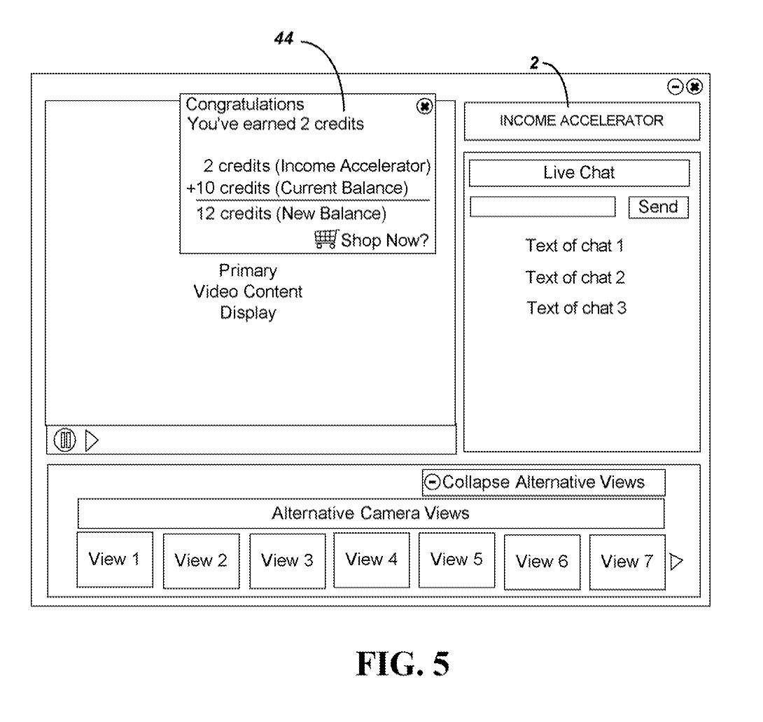

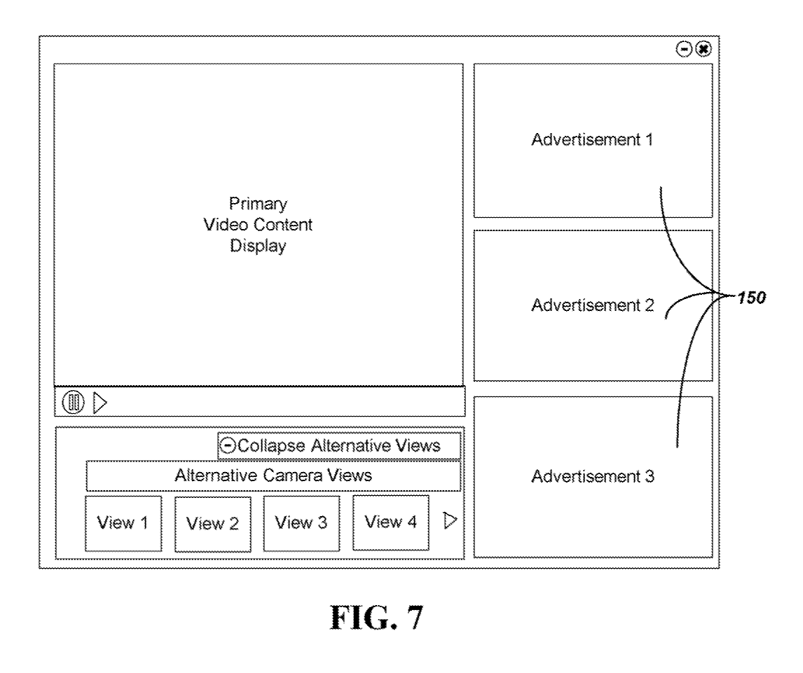

By electing to view advertisements, the user is rewarded with points that are deposited in his/her account as illustrated in the graphical user interface (GUI) 14 of FIG. 5 and the GUI 24 of FIG. 7. The reward points can then be used in the application's store for the purchase of merchandise, entries into multiple contests and giveaways, or donations to charity to provide aid to the user's favorite cause.

In addition to rewarding the user, others involved in the Income Accelerator system can benefit from revenue provided by an advertiser. For instance, the group performing in the video content (live, on demand or user-recorded) can earn a percentage of the advertising revenue generated during the Income Accelerator session featuring their performance. Revenue can also be shared by the service provider offering the Income Accelerator application program.

B. Associated Video Player

The Income Accelerator can be used with many types of websites a user views. One example of such a website is a video player shown in FIG. 1. The video player illustrated in FIG. 1 can be streaming video and audio from live events, as well as video record and playback.

The video player of FIG. 1 can allow the user to select from multiple camera angles at the bottom of the panel in the screenshot to be moved to the primary viewing area. This is illustrated by the alternative camera views 1-7 shown. For instance, at a rock concert the alternative camera views can be a separate back stage view to show the performer entering the stage area. An audience view can also be provided in another view. As another example, during a car race an in-car camera can be provided for different race drivers separate from the primary view of the race as a whole. The alternative views can be collapsed as shown using a cookie in FIG. 1 to increase the viewable area of other content.

The video player shown in FIG. 1 can include additional features, such as interactive controls to allow users to manage their experience. These features include live chat, as illustrated in FIG. 1. Further features can include video on demand, scheduling guides, and an interactive voting system. An on-demand center can offer users a collection of pre-recorded video for quick viewing and sharing. With on-demand, users may select from various channels of content from past live events, web content, and produced webisodes. The on-demand video content can allow users to post comments about the video, rate the videos, and add videos as favorites. For the video recording feature, the user can have control over a live streaming event with a recording control. Using an on-screen scheduling guide of segments from the stream's events, users can select past, current, and future segments to record on their user account. This process can link a recorded video's meta-data to the user's recording list for future retrieval of the video.

In addition to a video player, the Income Accelerator can be used with other websites. These sites might include a video gaming site, or a general website browser that displays items like news or other readable content, as well as many other websites. The video player can be based on Adobe Flash technology, as well as other streaming video player technologies such as HTML5, as discussed subsequently.

C. Technology Platforms Available for the Income Accelerator

The Income Accelerator includes but is not limited to software that will initially run as a widget on a content provider's website and include analytics that act upon data collected by a licensee or service provider. The Income Accelerator software forming the widget can interface with internal or external statistically predictive models to evaluate advertisement performance as well as video content performance. The Income Accelerator can be built upon the combination of several technologies and architectures, including but not limited to Television over Internet Protocol (TVIP), WebSphere, DB2, Windows Mobile, Android Operating Systems, iOS, Java, J2EE, HTML5, SOA (Service Oriented Architecture), Flash and API. More details from these technologies are described below.

The Income Accelerator on an Application Programming Interface (API) interfaces with the content provider's delivery vehicle to provide the core functionality of Income Accelerator. This functionality enables Income Accelerator to operate on a wide variety of websites and technology platforms following common technical standards. Income Accelerator securely records actions of users, including reporting scripts for advertisement publishers showcasing statistics regarding the effectiveness of their campaign. The API will also allow for the secure storage and retrieval of user data, advertising information and content provider information from a service provider's servers. The stored data can log account activity for each user, advertiser and content provider.

Service providers who distribute the Income Accelerator software can connect to the API to setup the necessary calls to run the platform. These calls can include setting a timer, retrieving advertisements, logging user clicks, retrieving a user's account balance, and depositing newly earned points to the user's account which are described in more detail subsequently. The rich media application (content provider) can be setup external to the Income Accelerator and can use a user-interface (UI) design that will connect to the API.

A service provider or licensee that operates income accelerator will be responsible for the collection of data from its users if such user associated data is desired. Use of an API or a similar program can provide this data. The data can be data-mined to demonstrate the value proposition of Income Accelerator to stake holders (content providers, advertisers, end users, and licensees) and enable best matching of end users, advertisers and content based upon metadata, preferences and predictive analytics.

End users receive value from the Income Accelerator through its functionality for the tracking and redemption of loyalty rewards points for the end users. Rewards can come in the form of coupons redeemable at selected retailers. Income Accelerator in some embodiments explicitly excludes a commerce engine and product fulfillment.

Advertiser value includes a receipt of metadata, preferences and predictive analytics through an Income Accelerator display termed a “dashboard” described in more detail subsequently. The “dashboard” enables a targeted precise view of end user habits, behaviors, preferences and likely future buying habits modeled into predictive analytic reporting enabling an advertiser to make real time decisions regarding placing future ads.

The content provider for programming which is served along with the advertisements receives value including licensing revenue from end user participation, advertising revenue, and unique targeted analytics to enable valuing its programming.

Income Accelerator enables differentiation from traditional and any known Internet content delivery, advertising, licensee and end user viewership models in that it can provide value to all four stake holders. With the Income Accelerator in particular, advertisers are rewarded with the benefit of a predictive analytics via the Income Accelerator dashboard.

D. Block Diagram Illustrating Income Accelerator System

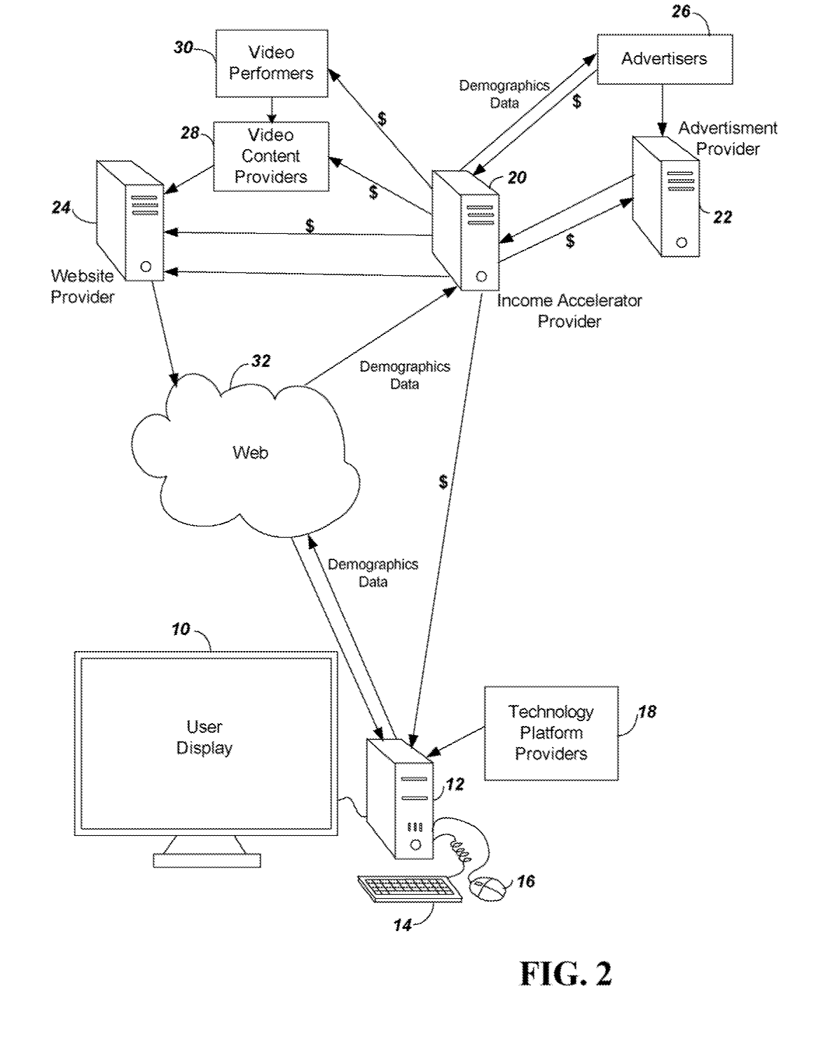

FIG. 2 is a block diagram illustrating the Income Accelerator system. The system includes a user display 10 that displays the content shown in FIG. 1, including the Income Accelerator 2. The display 10 can be a computer terminal or other display device, such as a television allowing the video content and Income Accelerator to be delivered by technology such as Web TV. The user system can include components such as computer 12 with keyboard 14 and mouse 16 to allow user interaction with the display content. The computer 12 can run a technology platform API such as Adobe flash or HTML5 as discussed previously herein, as illustrated by box 18 to enable delivery of the video content and the Income Accelerator program.

FIG. 2 further illustrates the interaction of the Income Accelerator provider with the user computer 12, as well as advertisers, the advertisement providers, video performers, video content providers and a Website provider. The Income Accelerator provider is illustrated as being hosted on a computer system 20 which may be a standalone computer or server system with software for the Income Accelerator application stored in the memory of the Income Accelerator computer 20.

FIG. 2 further illustrates the advertisement provider host computer 22 as well as a Website provider host computer 26 that integrates the video content and income accelerator content to provide to the user computer 12. The advertisement provider computer 22 either creates advertisement content or receives it as provided from the advertiser 26 and stores the data in advertisement host computer 22. The Income Accelerator host computer 20 then receives the advertisement content from computer 22 and integrates it into the Income Accelerator program that serves ads based on user activation of the Income Accelerator program as well as user demographics data gather from user activity. The Income Accelerator content is provided from the Income Accelerator provider 20 to a Website provider host computer 24 that also receives video or other display content the user computer 12 selects. The video content is provided from a separate video content provider 28 such as a movie company that employs performers 30. The website provider computer 24 provides the integrated content over the Web 32 for delivery to the user. Although shown on separate computers, the Income Accelerator computer 20, website provider computer 24 and advertisement provider computer 22 can be provided on a single computer. Similarly, although some communications are shown over the Web, while others are not, all or none of the communications can be provided over the Web.

Lines interconnecting the Income Accelerator provider computer 20 and other components illustrate the interactivity with content providers and the user. As illustrated, demographics and other data can be gathered from the user by the Income Accelerator provider computer 20 and delivered to the advertisers 26 as well as used to manipulate advertisement content served. In one example, advertisement providers receive demographics and data information such as when users purchase their advertised goods, if they alternatively purchase a competitor's goods, or how users respond to promotions.

The interconnecting lines with “$” signs further indicate how money received from advertisers 26 can be distributed using the Income Accelerator system. As shown, a portion of the advertiser money can be provided to the user as a reward for viewing advertisements and purchasing goods from the advertisers 26. Further, a portion of the advertiser revenue can be distributed to the advertisement provider, the video performers 30, the video content providers 28 and the website provider as shown. More details of the advertisement revenue distribution as well as demographics information provided using the Income Accelerator program are discussed subsequently.

Software for running the Income Accelerator program and data collected by the Income Accelerator program can be stored and distributed in a number of different ways. The Income Accelerator application program can be stored on a computer readable medium, such as the hard drive of the Income Accelerator provider's computer or server 20, or it can be stored off site of the host computer 20 in a cloud computing fashion and accessed by the host computer 20. Similarly, the data collected can be stored on the host computer 20 memory, or can be stored off site of the host computer, such as in cookies of the user computer 12.

### II. Income Accelerator Embodiment I—Timed Reward System

A first embodiment of the Income Accelerator, termed a timed reward version, and its operation will initially be described. The first embodiment is based on the length of time a user views advertisement content. In this embodiment, as well as subsequent embodiments, initiation of the Income Accelerator can be provided by pressing the Income Accelerator Button 2 in the top-right corner of the website as shown in FIG. 1. For this first embodiment, operation is described as follows:

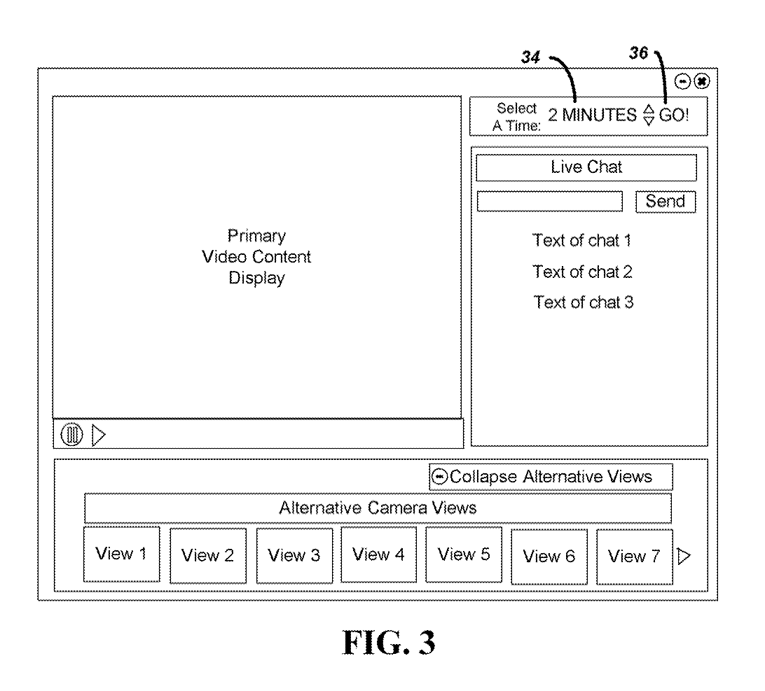

While viewing served media in the primary display and interacting with the rich media application, the user may elect to initiate an Income Accelerator session. This can be done by clicking the Income Accelerator button 2, as shown in FIG. 1. Once the user has pressed this button 2, a new graphical user interface (GUI) will be displayed with a selectable time 34 and Go! button 36 displayed as shown in FIG. 3. The user will select how long they wish for the Income Accelerator to run (e.g—3 Minutes, 2 Minutes, etc). Time may be selected by typing in an amount or clicking the up/down time control arrows. The longer the amount of time, the more a user can be rewarded for their participation in the program. After selecting a time, the user will hit the GO! button 6 and the Income Accelerator will begin.

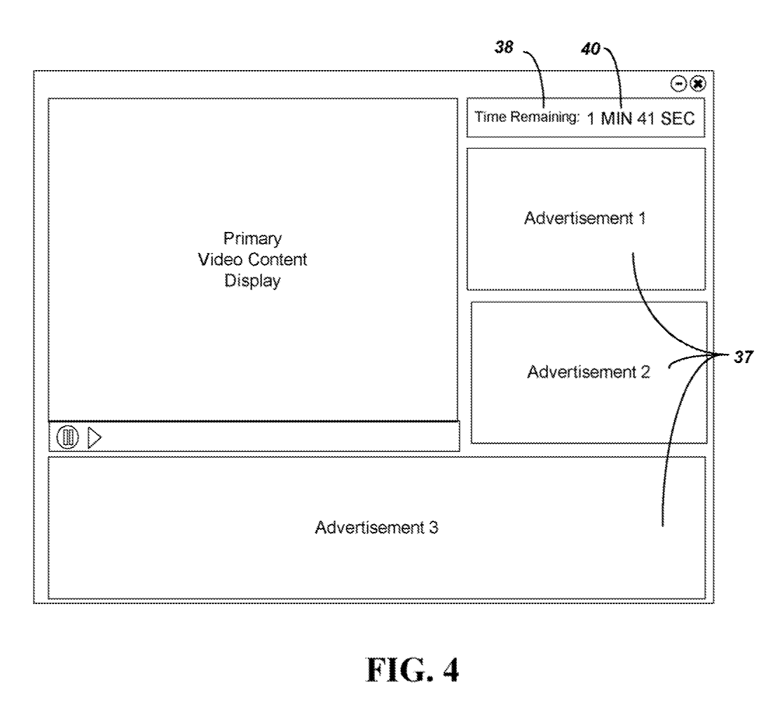

When the display of advertisements begins, active advertisement portals are displayed. Each active portal can feature the name of an advertiser and associated advertisement material alternating on a set interval of time. One advertisement can be shown at a time, or multiple advertisements can be displayed simultaneously, as shown by advertisements 37 in FIG. 4. The advertisements can be alternated continually during the time interval in which the Income Accelerator runs.

After initiation, the Income Accelerator works as follows. In the area where the Income Accelerator button was displayed, a display indicating “time remaining” 38 and showing the actual time 40 that remains will be displayed as shown in FIG. 4. During this portion of the Income Accelerator session, the rich media application will open panels around the viewing area, such as panels 37, serving relevant ads to the end user that can be based on their demographic and aggregated content from their account. Multiple advertisements will be displayed without disrupting the user's video viewing experience, which continues to be displayed. These are to be considered opt-in advertisements, and advertisements will cycle on a time sequence, providing the user multiple forms of advertising engagement throughout their elective session. In the top-right corner of the video screen, the user will continue to see a countdown of the remaining time 8 from the selected duration of their session.

Completion of the Income Accelerator session is illustrated in FIG. 5 where the user is rewarded. After completing the user's elective session, the user will be presented with an award of points deposited into their account on the hosted service as indicated in the GUI 44 of FIG. 5. As shown, the GUI 44 can present an accounting of the points accrued by the present viewing session (2 credits shown) along with the previous balance (10 points) and a total (12 points). The GUI 44 can also offer the user an opportunity to shop using the accrued credits for items provided in the Income Accelerator operator's store. The user can redeem points for items such as merchandise, contest entries, or donations to charity.

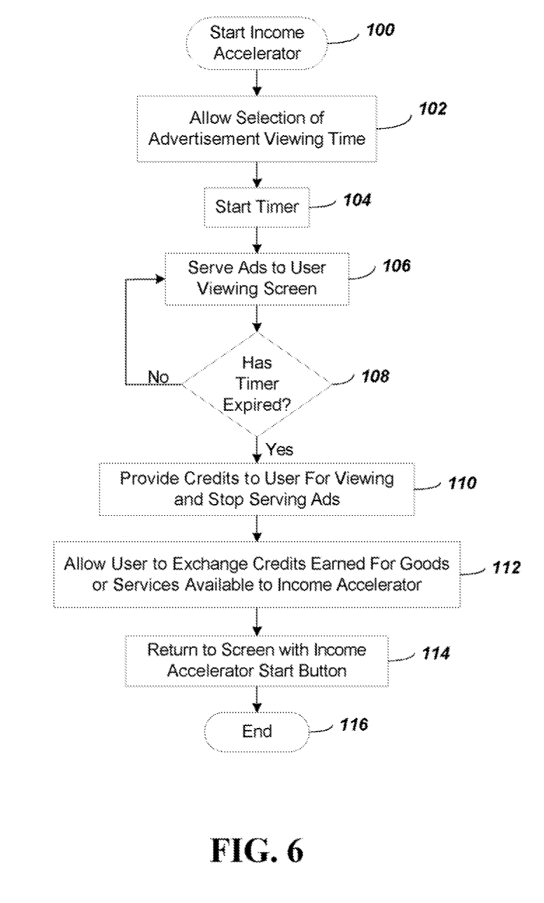

FIG. 6 provides a flow chart illustrating an example of operation under this first embodiment. Beginning in step 100, the Income Accelerator program is started by the user clicking the Income Accelerator start button. In step 102, the user is allowed to select a time for viewing advertisements, with increased time increasing the awards credited for viewing the ads. In step 104, the timer is started after the user clicks the GO button. In step 106, the system serves ads to the user viewing screen. In step 108, the system checks to determine if the timer has expired. If not, the service of ads is continued is step 106. If the timer has expired, operation proceeds to step 110 where the user is awarded credits that may be displayed in a GUI and the system stops serving ads. In step 112, the GUI can allow the user to proceed to a rewards screen where the credits can be exchanged for goods or services. In step 114, the system returns to the screen as shown in FIG. 1 where the Income Accelerator program button is displayed to enable a restart.

In one embodiment, the user's acquired reward points can be multiplied based on a combination of user activity factors. For example, the multiplied points can be based on the duration of the Income Accelerator session, and the amount of activity the user had with the advertisements being served. For instance, a user who views advertisements for 3 minutes, clicking on multiple advertisements, would be rewarded more points than a 1 minute session with no advertisement clicks.

In addition to a credits reward, in one embodiment free merchandise or services can be obtained as a reward. The free merchandise can be awarded in an arbitrary manner, like a jackpot feature on a slot machine. The free merchandise can likewise be awarded after a countdown of a select number of advertisement views occurs, either by a single user or multiple users.

Although the first embodiment illustrated in FIGS. 2 and 3 is shown with a selectable time period 34 that will determine how much a user will be rewarded, other methods of accruing awards are possible as described further herein. For instance, in this embodiment the total reward can be based on the number of times a user clicks to view an advertisement. In this embodiment a set amount, such as 1 minute, can be allocated without user input for display time of the advertisements during a run or Income Accelerator. This version of embodiment I can be expanded as detailed in the second embodiment described to follow.

A. Constraints to Prevent Computer Automated Abuse.

In an attempt to prevent system abuse by systems with computer automated viewing of advertisements, in one embodiment the Income Accelerator must be started over each time using the button 2. In another embodiment, the number of ads viewed per hour can be limited, for example to 80. Other schemes can likewise be used to prevent abuse. For instance, a user can be asked to type in information displayed in an unusual manner that cannot be read by an automated computer system to verify the user click. In another example, the user can be asked a question or the user can log in with verification information on a regular basis to assure their clicks are genuine. Although described with this first embodiment, the above techniques to prevent computer automated abuse similarly apply to embodiments of the invention described subsequently.

B. Income Accelerator Activation Process

As a first activation technique, the Income Accelerator (IA) is an application program that can be downloaded by a user. The IA program can then be provided with any content viewed on a viewing system, such as Web-TV, a video gaming system, or it can be attached to a browser. As a second activation technique, the IA program can be provided with software for specific video content. As an option in this second activation technique, the IA program can then be activated to function with other video content that is subsequently viewed by a user. In a third activation technique, the IA program can be provided with a device such as a Web TV or a gaming device. In any of the three described activation techniques, the user can actively turn the IA program on and off. The IA program can optionally be set to automatically turn on with the programming or video device, or it can be set so that the user must activate the IA program each time use of the program is desired. Although described with this first Income Accelerator embodiment, the above activation techniques to activate the Income Accelerator program can similarly apply to embodiments of the invention described subsequently.

### III. Income Accelerator Embodiment II—The Pay-Per-Multi-Click System

In this second Income Accelerator embodiment, termed a pay-per-multi-click revenue version, the advertiser will pay the website owner for several participant mouse clicks into an active advertisement portal. For example, a participant sees an XYZ company advertisement and clicks on the active portal bearing the XYZ company name. The click will reveal a list of XYZ company products. The participant clicks again on the product name for a more detailed description of the product and/or specific advertisements for the brand's specific product. For each mouse click, XYZ company pays the company providing the Income Accelerator program. A portion of the advertiser money is paid as a reward to the user selecting the advertisement.

The user can select products he/she finds appealing, and can elect to place the item on their store wish list. Every period of time, such as three months, a company associated with the provider of the Income Accelerator program can place the contents of its store on sale to the specific wish list account holder, potentially at steep discounts. This pay-per-multi-click revenue version can also be termed the three click version as a user can receive a reward based on three different clicks, a first to select an advertisement, a second to select a product from an advertiser's store, and a third to purchase the product selected.

FIG. 7 illustrates a first window of this pay-per-multi-click alternative embodiment for the present invention. FIG. 7 shows a viewer's screen after the Income Accelerator is initiated. The screen displays three advertisements 150 in the right-hand side for a user to view. The Income Accelerator can be initiated automatically in one embodiment so that the advertisements can continually be displayed while video content is displayed at the left of the screen. Alternatively, the Income Accelerator start button 2, as shown in FIG. 1, can be used to activate the Income Accelerator and initiate display of the advertisements. Providing the Income Accelerator start button 2, as opposed to automatically providing advertisements, allows the user to choose to occupy more of the screen with the video player when needed. With the automatic version, a right click feature can then be provided to end the display of advertisements when desired. This can allow more space for the video or other content to be displayed when needed.

Note that although three advertisements 150 are shown at the right of FIG. 7, any number of advertisements can be displayed at any location on the screen. The advertisements can be alternated with other advertisements every set period of time. Similarly, once an advertiser's store is selected its items can be replaced every set period of time. The time period can be user-selected, or automatically set by the Income Accelerator provider. In one version, all displayed ads or items are replaced every set time period. In another version, the advertisements are scrolled up with a new advertisement replacing one of the advertisements that are scrolled out. A set period of time can similarly be provided for viewing an advertiser's store or a user's wish list, or a feature can be provided to allow the user to selectively leave the advertiser's store or user's wish list.

Rewards using the system of FIG. 7 can be obtained by the three click system, as indicated above. More details of the three click system are provided below.

Prior to the first click, the advertisements 150 are displayed and replaced by other advertisements periodically. In one embodiment, the advertisements are replaced every thirty seconds before a new set of advertisements is provided. Unlike previous embodiments, no credits or other reward is provided to the user for viewing the advertisements. Further, nothing is charged to the advertisers until a first click on an advertisement. However, in alternative embodiments, an added reward can be given to the user for simply viewing the ads.

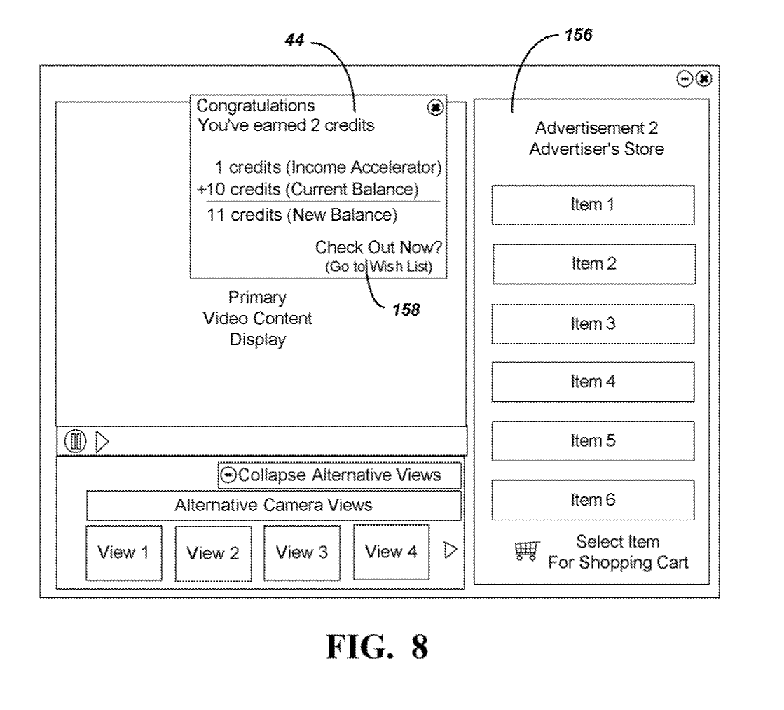

With a first click the user selects one of the advertisements 150 at the right by clicking on it. The click will take the user to the store 156 as shown in FIG. 8 where the user can select from items in the advertiser's store to put into a wish list or shopping cart. The advertiser's store of items 156 allows a user to select from items displayed in a specific viewing area 156, or alternatively over the entire screen. The advertiser's store can be displayed for a select period of time, and if no activity within the store is detected from the user, the screen will return to displaying another set of advertisements. Alternatively, a user prompt can be provided to allow the user to select when to leave the store.

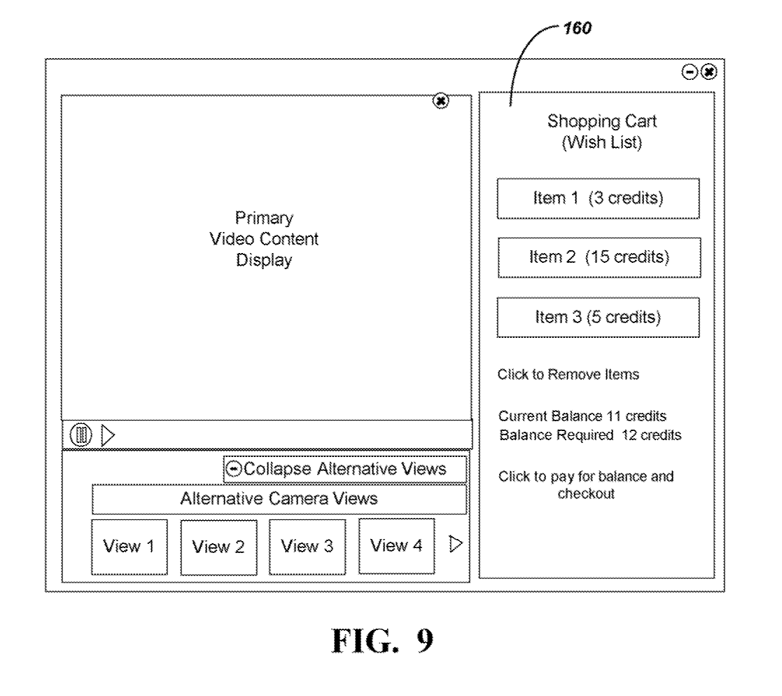

A GUI 44 can be displayed when the advertiser's store is displayed as shown in FIG. 8, the GUI 44 showing user-earned credits and a total balance of credits the user has accrued. As illustrated, the user will receive a credit (1 credit shown) for viewing the advertisement that is added to the user's accrued credit. The GUI 44 allows the user to check out, or go to the user's wish list shown in FIG. 9 if the user desires to purchase items selected.

The reward provided to the user is part of the amount paid by an advertiser when the user clicks to view the advertiser's store. Other portions of the money paid by the advertiser for the user's first click in this embodiment can be provided to the video content provider, the system operator, and others. The user does not receive a reward, and the advertiser pays nothing, until the user goes to an advertiser's store. No purchase from the store is required for the reward. In one exemplary embodiment, for the first click to go to the advertiser's store, the advertiser pays 25 cents for every advertisement viewed by the user. The distribution of revenue from advertiser payments can be made as follows:

15% content provider (company supplying the video content)

40% website provider who supplies both the content and ads

3% for advertising and marketing generation company

32% for Income Accelerator application provider

10% to user who puts item in shopping cart.

A second click in the system can be made by the user to select one of the items listed in GUI 156 in the advertiser's store. The second click in this embodiment provides a further reward to the user, as well as the video content provider, the system operator, and others that are charged to the advertiser. The additional accrued reward can be displayed in GUI 158. Again, no purchase is required for the further reward. A greater reward than provided for the first click, can be provided for every item a user second clicks to put in a wish list in one embodiment, such as 2 credits instead of the 1 credit shown for simply going to the advertiser's store, if desired.

A third click can be made by a user to purchase items on a wish list. This third click can be provided in the GUI 44 as shown in FIG. 8, or in another location. The third click will cause display of the shopping cart or wish list 160 as shown in FIG. 9. This third click can provide a further reward to the user as well as the video content provider, the system operator, and others that again are charged to the advertiser. A greater reward than provided for the first and second clicks can be provided to the user for this third click if desired.

Items that are purchased with the third click can be purchased either entirely from reward credits collected from the first, second and third clicks, from a combination, or the reward collected and user payment as illustrated in store 160 if the user doesn't have enough reward points. Alternatively, items can be purchased based on user payment alone if desired.

In one embodiment, when the second click is made by a user, a notice is provided to the user when enough reward credits are available for the user to purchase items on their wish list with the reward credits alone.

In yet another embodiment, an enticement can be made to the user to encourage them to purchase using a third click. For example, a notice can be provided in GUI 44 stating “purchase now and receive 50% off.”

As a bonus for advertisers for the Income Accelerator, no costs are associated with the ads until the consumer shows an interest in their products.

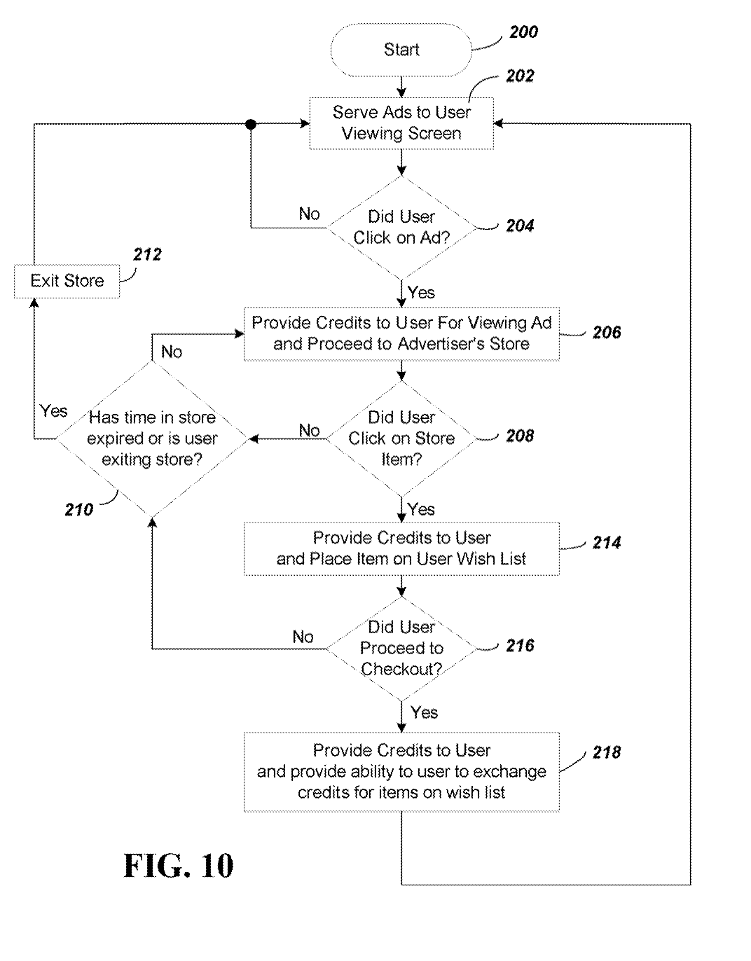

FIG. 10 provides a flow chart illustrating an example of operation under this second embodiment. Operation begins in step 200 where and ads are served to the viewer screen 202 as illustrated in FIG. 7. In step 204 the system checks to determine if a user clicked on an ad. If not, the service of ads continues in step 202. If the user did click an ad, in step 206 credits are awarded to the user and the advertiser's store is displayed. The advertiser's store is continually displayed with system checks performed in step 208 to determine if the user selected a store item. If the user does not select a store item, the process moves to step 210. In step 210 if the user clicked to exit the store or the time out period for viewing the store items has expired, the store is exited in step 212 and operation proceeds back to step 202 to continue to serve ads. In step 210 if the store is still being viewed and the timer hasn't expired, operation proceeds back to step 206 to the store. If step 208 determines a user has selected a store item, in step 214 additional reward credits are provided to the user and the selected item is placed in the user's wish list. Next in step 216 the system determines if the user has proceeded to checkout. If not, operation proceeds back to step 210 to determine if the advertiser's store should continue to be displayed. If the user has proceeded to checkout in step 216, additional credits are awarded in step 218 and the user is permitted to exchange the reward credits to purchase items on his or her wish list. After checkout in step 218, operation proceeds back to step 202 where ads are again served to the user.

Note that although operation is described with a first, second and third click, it is understood that a user might otherwise make selections by touching a screen area, typing a keyboard entry, or other procedure as opposed to using a mouse click.

In an attempt to prevent system abuse using computer-automated clicks, the same techniques can be applied as in the first embodiment. Additionally, with this second embodiment, since user credit is given with a second click to select items for a shopping cart, the number of items that can be selected per hour by a user to put into his or her shopping cart using a second click can be limited. In one example, the limit could be 20 items per hour.

### IV. Income Accelerator Embodiment III—Advertiser Metrics Feedback Reward System

In a third embodiment of the Income Accelerator, metrics data are provided to the advertiser as a reward when a user clicks on an advertisement or otherwise views an advertiser feature that results in advertiser payment for user viewing. Although this third embodiment can be provided in conjunction with a user reward system as described in embodiments I and II, in some embodiments the advertiser reward of metrics data can be used without providing a separate reward to the user.

The metrics can be provided to an advertiser based on the individual user accessing the advertisement, or as a “dash board” display covering real-time data of multiple users. For individual user information, the data reward provided to the advertiser might include cookie data such as previous advertisements viewed by the user, the user's age, gender, and viewing habits. Once multiple selections of the advertiser's products are selected by the identifiable user, the advertiser can then provide discounted rates directed to the individual user. Data from clicks of all individual users selecting the advertiser's products will give the advertiser a collection of demographics information from its customers in a real-time fashion providing information that can be compiled over time into the “dash board” display described to follow.

The “dash board” display information from multiple users can provide a significantly greater variety of information to an advertiser. For instance, the data can include the total number of viewers watching a single football game on which the advertiser's ad is posted. By identifying the number of people on line using the Income Accelerator watching different television programming, the dash board thus provides information similar to Nielsen TV ratings that are compiled and provided real-time throughout the show. In addition to the number of people watching, other dash board information can be provided such as the age range of viewers, whether they are primarily male or female, and preferences the viewers have for particular advertisements based on data collected through cookies or other means.

FIG. 10 shows an exemplary “dash board” display containing metrics data. The example display includes a first column at the far left showing the type of video available and the channel. For instance channels 1-4 are TV shows and channels 5 and 6 are interactive video games. The name or identification of the video is listed in the next column from the right, then number of viewers, the percent male or female, the number of viewers in age ranges 10-30 and 30-60, and finally the type of advertisement most viewed is listed. The data can be interactively changed in a real-time fashion throughout the television shows. The data can also be collected over a time period, such as over a thirty-minute time slot of a typical TV show, and the data collectively displayed along with an indication of the time period over which the data is collected. Although certain data is shown in the dash board display of FIG. 10, it is understood that a significantly greater number of categories could be provided.

Using the “dash board” an advertiser might request that his or her company advertisements be pulled if the number of people watching is significantly less than expected. Further, an advertiser viewing the dash board might pull advertisements if a different demographic character is watching than expected. For example, during a football game if the expected audience is male ranging from 30-60 years, but instead the average audience watching turns out to be is female ranging from 10-30 years old, the advertiser might want to pull a men's electric shaver commercial.

Viewers clicking on advertisements will also allow the dash board to provide interactive data about how groups of users respond to the ads displayed. For instance, men age 30-60 might more readily click on a blue jeans advertisement rather than a beer rebate advertisement. Accordingly, more blue jeans advertisers might post more ads while beer companies might pull their advertisements during the game.

In one embodiment, the user can be allowed to block advertisements, and the metrics provided to an advertiser or others can indicate that an advertisement has been blocked. For instance, an advertisement with adult content can be blocked by a parent when a child is watching video content. The blocking can be done by the parent interactively immediately when the advertisement begins displaying an ad, or metadata can be identified by a user such as metadata indicating the advertisement contains adult content that will block all adult content ads that might be displayed to the individual user.

With this blocking data, the advertiser will know when it could be a waste of time and money for them to provide an advertisement since a majority of viewers will block the advertisement from viewing. The advertiser might also decide to provide ads it otherwise would not serve during a particular video, as they would no longer have the worry of viewers who might object to the content viewing the advertisement. The ability to block advertisements by a user in combination with providing this information in metrics to an advertiser will, thus, provide an advantage to both the advertiser and the user.

To prevent abuse of the blocking feature to block all advertisements, limits can be put on advertisements that are blocked. The blocking feature might otherwise allow users of a service, such as a Web TV that only serves ads using the Income Accelerator, to block all ads and view programming without the advertisements that pay for the service. Allowing blocking of all of a certain category of ads, such as mature-audience-only ads, could still be an option.

The metrics data provided to an individual advertiser can include user clicks on an advertiser's products, as well as purchases made of competitor products by users. For instance, an advertiser of jeans can see that a competitor's jeans are purchased more often. This can allow the advertiser to offer discounts to encourage purchase of their own jeans, or to identify problems indicating why a purchaser would prefer a competitor's product over their own.

The advertiser metrics data combined with the user reward system of the first and second embodiments described is similar to couponing, where a user can redeem a coupon for discounts to encourage them to view advertisements, and the advertiser can collect data on consumer interest by collecting data from the coupons distributed and those redeemed.

### V. Income Accelerator Embodiment IV—Metrics Data Sale and Auction System

In this fourth embodiment, the metrics and demographics information can also be provided to others via sale or auction. In a third embodiment of the Income Accelerator the metrics data was provided to the advertiser as a reward when a user clicks on an advertisement or otherwise views an advertiser feature that results in advertiser payment for user viewing. The advertiser receives this data for free, or alternatively for a minimal charge. To increase revenue in this fourth embodiment, the data can be provided to other advertisers who did not have their ads selected by the user, or even non-advertisers interested in the data.

The metrics on the “dash board” display and also the data from individual advertisement selections by a user can, thus, be provided to subscribers other than ones who have advertisements selected. The advertisers getting the data for free can get the data up to the time of the user click, or for a time period after a user clicks the advertiser's ad. The non-advertisers who pay can also view these metrics and demographics for either a single time period or over an extended time, enabling them to provide advertisements at a later time once they know the metrics about the viewers.

To further increase revenue, in some embodiments a bidding process can be implemented to allow advertisers to compete to have their ads displayed. The metrics obtainable in this embodiment combined with bidding allow the advertisers to value their ads and bid to place their ads during a show in a real-time fashion. A bid can then be set by the advertisers for a time slot in an interactive manner, with the highest bidder having their ad displayed. If no other bidders exist, or other bidders only paying a minimal amount, the advertiser can benefit by paying less for the timeslot than otherwise would be paid.

With more advertisers than space available, the bidding system gives an advertiser a better chance of getting a desirable ad time than through a first-come-first-served sales basis. As a reward to advertisers with ads selected by users over a threshold amount, their ads could be enabled to win the bidding process even if they are not the high bidder for a timeslot. The bidding process can be particularly important if the system has a limited number of ads served per hour. With a limited number of ads served per hour and highly desirable programming, bidding can help both the advertiser who wants ads served and the video content provider who will receive more revenue from advertisements than he or she might otherwise have with flat-rate advertisement.

Even without more advertisements served per hour than available slots, the bidding process can still be made valuable. For instance, ads can be served on a rotation basis, with an even more limited spacing per hour than the maximum that can be served on the system. In this manner, limited advertising space can still be exceeded by advertisers desiring space. And advertisers can then bid to get their ads in the limited space.

Although embodiments of the present invention have been described above with particularity, this was merely to teach one of ordinary skill in the art how to make and use the invention. Many additional modifications will fall within the scope of the invention, as that scope is defined by the following claims.

What is claimed is:

1. A method for providing advertisements on a computer system, the method comprising:
providing a web page with an icon allowing commencement of an Income Accelerator program;
providing a user with a portal after commencement of the Income Accelerator program, the portal providing a timer which during countdown after activation allows the user to collect credits;
serving advertisements to the user after activation of the timer;
displaying the number of credits earned by the user after the countdown has expired; and
allowing the user to exchange the credits earned for a reward.

2. The method of claim 1, further comprising:
determining how many times a user clicks on advertisements during provision of the user with a portal until the countdown expires, and increasing the credits collected by the user based on the number of the clicks on advertisements.

3. The method of claim 1, wherein:
the method is embodied as a set of computer instructions stored on a computer readable media, said computer instructions when loaded into a computer causing the computer to perform the steps of the method.

4. A method for providing advertisements on a computer system, the method comprising:
providing to a user a web page that contains viewable content and an Income Accelerator program that provides advertisement content separate from the viewable content;
providing a number of credits earned to a user when the user selects first advertisement content provided by a first advertiser;
directing the user to a store of the first advertiser when the user selects the first advertisement;
providing an additional number of the credits earned to the user when the user selects a first item from the store of the first advertiser;
placing the first item in the user's wish list; and
allowing the user to exchange the credits earned for a reward.

5. The method of claim 4, further comprising:
providing an additional number of the credits earned to the user when the user purchases an item from the wish list.

6. The method of claim 5, wherein the reward can include the first item in the wish list.

7. The method of claim 4, wherein data from the user's selections is provided to the first advertiser.

8. The method of claim 4, further comprising:
providing a web page with an icon allowing commencement of the Income Accelerator program.

9. The method of claim 4, wherein the step of providing to the user a web page includes providing the advertisement content to the user as controlled by a timer.

10. The method of claim 4, wherein selection comprises identifying the first advertisement content by placing a mouse-driven icon over the advertisement and clicking a mouse button.

11. A method for providing advertisements on a computer system, comprising:
providing to a user a web page that contains viewable content and an Income Accelerator program that provides advertisement content separate from the viewable content;
determining when the user selects first advertisement content provided by a first advertiser;
determining metrics about the user selecting the first advertisement content; and
providing the metrics to the first advertiser on a real-time basis after the user selection as a reward to the first advertiser for the user selecting the first advertisement content.

12. The method of claim 11, further comprising:
determining additional metrics from other users of the Income Accelerator program for the viewable content and other viewable content; and
providing the additional metrics to the first advertiser as a reward for the user selecting the first advertisement content.

13. The method of claim 11, further comprising selling the metrics and the additional metrics to an entity other than the first advertiser.

14. The method of claim 11,
wherein the Income Accelerator program serves a limited number of advertisements over a period of time to the user, the method further comprising:
providing an auction to allow advertisers to bid for the right to place advertisements in the limited number of advertisements.

15. A method for providing advertisements on a computer system, comprising:
providing to a user a web page that contains viewable content and an Income Accelerator program that provides advertisement content separate from the viewable content, wherein the Income Accelerator program serves a limited number of advertisements over a period of time to the user; and
providing an auction to allow advertisers to bid for the right to place advertisements in the limited number of advertisements.

16. A method of providing video for an event to a user on a single viewable screen comprising:
providing a primary view of the video event on the screen;
providing secondary views on the screen that relate to the event, the secondary views provided in a smaller viewing area than the primary view; and
allowing the user to select one of the secondary views that can be substituted in as the primary view.

17. The method of providing video of claim 16, further comprising:
providing at least one advertisement on the screen.
